(19) United States
(12) Patent Application Publication
(10) Pub. No.: US 2017/0372410 A1
(43) Pub. Date: Dec. 28, 2017

(54) HYBRID DISPATCH MANAGEMENT SYSTEM FOR SCHEDULED AND REAL-TIME EVENTS

(71) Applicant: Skurt, Inc., Dana Point, CA (US)

(72) Inventors: Joshua Fruhman, Hale Barns (GB); Ilteris Canberk, Los Angeles, CA (US); Aatish Nayak, Monmouth Junction, NJ (US)

(21) Appl. No.: 15/586,401

(22) Filed: May 4, 2017

Related U.S. Application Data
(60) Provisional application No. 62/354,186, filed on Jun. 24, 2016.

(51) Int. Cl. G06Q 30/06

(52) U.S. Cl. CPC G06Q 30/0645

(57) ABSTRACT

A system includes a memory and at least one processor to select a particular available service provider from a list of service providers for a particular event in a subset of a list of events, the particular available service provider selected based on a ranking of the particular available service provider and the particular available service provider having a lowest distance between the current location of the particular available service provider and the location associated with the particular event in the subset of the list of events, transmit a notification to a client computing device associated with the particular available service provider, and receive a confirmation from the client computing device that indicates whether the particular available service provider accepts or declines the particular event in the subset of the list of events.

### CROSS-REFERENCE TO RELATED APPLICATION

This application is related to and claims priority under 35 U.S.C. §119(e) to U.S. Patent Application No. 62/354,186, filed Jun. 24, 2016, entitled “Hybrid Dispatch Management System for Scheduled and Real-time Events,” the entire contents of which are incorporated herein by reference.

### BACKGROUND

Computing devices have gradually become ubiquitous and a part of daily life. Users of smartphones and tablets have access to a portable device that is capable of communicating with others, capable of executing applications, and capable of sending information to other devices and receiving information from other devices.

It has become common practice for a user to utilize an online travel agency (OTA) website or a car rental agency website to make a car rental reservation. A user may reserve a vehicle at a particular location/airport, travel to the particular location/airport via air travel or another method of transport, and make their way to a car rental agency kiosk at or near the particular location/airport. The user may have to board a car rental shuttle with a large amount of luggage and wait in a line at the car rental agency kiosk. Upon arrival at the kiosk, the user may have to wait for the vehicle to be ready, may be encouraged to obtain insurance and/or prepaid expensive gasoline, may have to pay a premium based on their age, and eventually locate the vehicle in a large, dimly lit parking lot or garage. In addition, employees of the car rental agency kiosk are encouraged to upsell other aspects of the car rental and often provide poor customer service. This process may be an exhausting, exasperating, hours-long process. Renting a vehicle is expensive, difficult, burdensome, time-consuming, and annoying.

It is with these issues in mind, among others, that various aspects of the disclosure were conceived.

### SUMMARY

According to one aspect, a hybrid dispatch management system for scheduled and real-time events is provided for receiving at least one rental request and storing the rental request as an event in a list of events in a database, determining a current location of a client computing device for each available service provider user from a list of service providers, determining a subset of the list of events that are to occur during a future period of time, determining a location associated with each event in the subset of the list of events, selecting a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events, and transmitting a notification to the client computing device associated with the particular available service provider and receiving a confirmation from the client computing device that indicates whether the particular available service provider accepts or declines the particular event in the subset of the list of events.

According to another aspect, a method includes receiving, by a processor, at least one rental request and storing the rental request as an event in a list of events in a database, determining, by the processor, a current location of a client computing device for each available service provider user from a list of service providers, determining, by the processor, a subset of the list of events that are to occur during a future period of time, determining, by the processor, a location associated with each event in the subset of the list of events, selecting, by the processor, a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events, and transmitting, by the processor, a notification to the client computing device associated with the particular available service provider and receiving a confirmation from the client computing device that indicates whether the particular available service provider accepts or declines the particular event in the subset of the list of events.

According to an additional aspect, a non-transitory computer-readable storage medium includes instructions stored thereon that, when executed by a computing device cause the computing device to perform operations, the operations including receiving at least one rental request and storing the rental request as an event in a list of events in a database, determining a current location of a client computing device for each available service provider user from a list of service providers, determining a subset of the list of events that are to occur during a future period of time, determining a location associated with each event in the subset of the list of events, selecting a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events, and transmitting a notification to the client computing device associated with the particular available service provider and receiving a confirmation from the client computing device that indicates whether the particular available service provider accepts or declines the particular event in the subset of the list of events.

These and other aspects, features, and benefits of the present disclosure will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 is a block diagram of a vehicle dispatch system according to an example embodiment.

FIG. 2 illustrates a block diagram of a client computing device according to an example embodiment.

FIG. 3 illustrates a block diagram of a server computing device of the system according to an example embodiment.

FIG. 4 illustrates a database table of the system according to an example embodiment.

FIG. 5 illustrates a flowchart for optimally simulating a list of events according to an example embodiment.

FIGS. 6-10 illustrate example screenshots of user interfaces of a vehicle dispatch application according to an example embodiment.

FIG. 11 illustrates a block diagram of an example computer device for use with the example embodiments.

### DETAILED DESCRIPTION

For the purpose of promoting an understanding of the principles of the present disclosure, reference will now be made to the embodiments illustrated in the drawings, and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates.

The client computing devices and the server computing device communicate over a communications network using Hypertext Transfer Protocol (HTTP) and/or other communications protocols. HTTP provides a request-response protocol in the client-server computing model. A client application running on the client computing device may be a client and a server application running on the server computing device may be the server, e.g., a web server. The client submits, for example, an HTTP request to the server. The web server of the server computing device provides resources, such as Hypertext Markup Language (HTML) files and/or other content, and performs other functions on behalf of the client, and returns an HTTP response message to the client. Other types of communications using different protocols may be used in other examples.

The one or more computing devices may communicate based on representational state transfer (REST) and/or Simple Object Access Protocol (SOAP). As an example, a first computer (e.g., a client computer) may send a request message that is a REST and/or a SOAP request formatted using Javascript Object Notation (JSON) and/or Extensible Markup Language (XML). In response to the request message, a second computer (e.g., a server computer) may transmit a REST and/or SOAP response formatted using JSON and/or XML. Aspects of a system and method for vehicle dispatch provide a client application for creating a vehicle pickup request or a vehicle return request and submitting the vehicle pickup request or the vehicle return request to a server. The server receives the vehicle pickup request or the vehicle return request and a server application processes the vehicle pickup request or the vehicle return request to create an event that is stored in a database. The server performs a simulation of assigning each event in a subset of the events to occur over a particular period of time, e.g., the next three hours, to a particular service provider. The server may repeatedly perform this simulation. In addition, aspects of the system and method for vehicle dispatch include a client application for receiving notifications and messages from the server associated with vehicle pickup requests and vehicle return requests. The server sends notifications to client computing devices associated with the particular service providers. Each service provider may carry the client computing device on their person to each vehicle pickup request and vehicle return request.

For example, a customer user may request a vehicle to rent for a period of time using the client application. The client application may transmit a request to the server application. Alternatively, the customer may request a different type of good or service for the period of time. As an example, the customer may request delivery of food or delivery of a professional to provide professional services (e.g., an entertainer, a doctor) to a specific location at a particular time or a particular time window. The server application receives the request, processes the request, sends a message to a service provider client computing device, sends a message to the customer client computing device, receives a response from the service provider, and a service provider assists with dispatching a vehicle to a location associated with the user. The customer client computing device may be a first smartphone, the service provider client computing device may be a second smartphone, and the vehicle may be a rental vehicle.

In another example, a user may send a vehicle return request using the customer client computing device. The customer client computing device may transmit the vehicle return request to the server application. The server application receives the request, processes the request, sends a message to the service provider client computing device, sends a message to the customer client computing device, receives a response from the service provider client computing device, and the service provider assists in returning a vehicle to an appropriate return location.

A user may also modify the time of the request to rent the vehicle or the vehicle return request using the customer client computing device or may cancel the request to rent the vehicle. If the user changes the time or cancels the request, then the server application may update the request to “cancelled” in the database.

Conventional dispatch systems may operate in one of two limited ways. The dispatch system may batch optimize schedules at a beginning of a day or the dispatch system may receive and assign tasks in real-time only. According to an exemplary embodiment, a vehicle dispatch system, e.g., the server, receives vehicle pickup requests from a plurality of users and vehicle return requests from the plurality of users. At a particular interval of time, e.g., every forty-five seconds, the vehicle dispatch system determines available service providers and simulates assigning vehicles and service providers to particular vehicle pickup requests and vehicle return requests during a future period of time, e.g., three hours. The vehicle dispatch system determines an optimal simulation of assignments at the particular interval of time based on a location associated with each vehicle pickup request/vehicle return request, availability of vehicles, availability of service providers, a location associated with an appropriate service provider to assist with each vehicle pickup request/vehicle return request, and traffic, among other factors. Based on the optimal simulation, the vehicle dispatch system assigns events for each vehicle pickup request/vehicle return request including assigning a particular service provider to fulfill each vehicle request at a particular time. The vehicle dispatch system may send a message to a particular service provider client computing device that requests that the service provider accept the event. The service provider client computer device may receive the message, the service provider may accept the event, and the service provider client computer may send a response to the vehicle dispatch system that indicates that the event has been accepted. At this point, the associated event may be removed from future simulations of vehicle assignments.

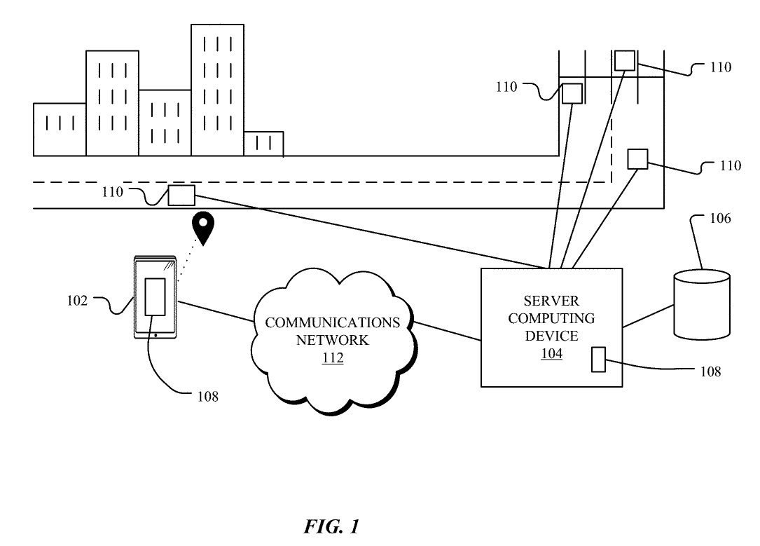

FIG. 1 shows a block diagram of a computing system that includes a vehicle dispatch system 100 according to an example embodiment. The vehicle dispatch system 100 includes at least one client computing device 102 that is in communication with at least one server computing device 104 via a communications network 112. In addition, the vehicle dispatch system 100 includes a plurality of vehicles 110 that are in communication with the server computing device 104 via the communications network 112. The vehicle 110 may be a machine that transports people and/or cargo including a terrestrial motor vehicle, a watercraft, and an aircraft, among other vehicles.

The at least one client computing device 102 may have a client component of a dispatch management application 108 and the at least one server computing device 104 may have a server component of the dispatch management application 108 that communicates with at least one database 106 that comprises a non-relational database and/or a relational database for storing vehicle information, user information, and dispatch information, among other data. As an example, the information may be stored in a relational database management system (RDBMS), an open source distributed database management system such as a Not only SQL (NoSQL) database management system, an in-memory database (IMDB) management system, or another appropriate database management system. As an example, each vehicle 110 associated with the system 100 may have associated information stored in the database 106 and each user of the system may have associated information stored in the database 106.

As an example, vehicle reservations may be stored in a first table of the database 106, real-time service provider locations and vehicle locations may be stored in a second table of the database 106, and user account information (e.g., username/password information) may be stored in a third table of the database 106. Other tables may store additional information such as vehicle information and service provider information, among other information. Each vehicle reservation may have a particular identifier that is used to reference the vehicle reservation in the database 106. In addition, each vehicle 110 may have a particular identifier that is used to reference the vehicle in the database 106. The location of each of the vehicles 110 and the location of each of the client computing devices 102 associated with the vehicle dispatch system may be continually updated in the database 106. A vehicle location may be determined using one of a location of the vehicle 110 or a location of the client computing device 102.

The at least one server computing device 104 is configured to receive data from and/or transmit data to the at least one client computing device 102 through the communications network 112. In addition, the vehicle 110 is configured to receive data from and/or transmit data to the server computing device 104 through the communications network 112. Although the at least one server computing device 104 is shown as a single server, it is contemplated that the at least one server computing device 104 may include multiple servers, for example, in a cloud computing configuration.

The one or more computing devices communicate and coordinate their actions by passing messages over the communications network 112. The communications network 112 can be one or more of the Internet, an intranet, a cellular communications network, a WiFi network, a packet network, or another wired and/or wireless communication network or a combination of any of the foregoing. As an example, the one or more computing devices communicate data in packets, messages, or other communications using a common protocol, e.g., Hypertext Transfer Protocol (HTTP) and/or Hypertext Transfer Protocol Secure (HTTPS). As an example, the vehicle dispatch system 100 may be a cloud-based computer system or a distributed computer system.

The dispatch management application 108 may be a component of an application and/or service executable by the client computing device 102 and/or the server computing device 104. For example, the dispatch management application 108 may be a single unit of deployable executable code or a plurality of units of deployable executable code. According to one aspect, the dispatch management application 108 may be a web application, a native application, and/or a mobile application (e.g., an app) downloaded from a digital distribution application platform that allows users to browse and download applications developed with mobile software development kits (SDKs) including the App Store and GOOGLE PLAY®, among others. The dispatch management application 108 may be installed on the client computing device 102, which may have the iOS operating system or an ANDROID™ operating system, among other operating systems. In an exemplary embodiment, the dispatch management application 108 may include a first client component executed by the client computing device 102 and a second server component executed by the at least one server computing device 104.

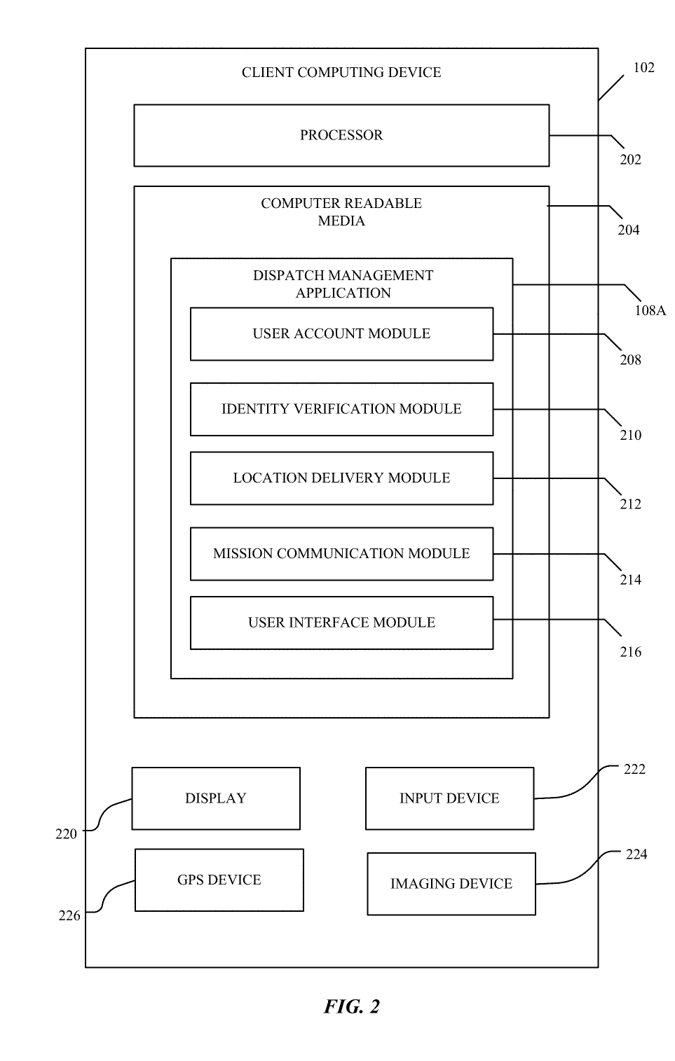

FIG. 2 illustrates a block diagram of the client computing device 102 according to an example embodiment. The client computing device 102 may be a computer having a processor 202 and memory, such as a laptop, desktop, tablet computer, mobile computing device (e.g., a smartphone), a wearable device, or a dedicated electronic device having a processor and memory. The one or more processors 202 process machine/computer-readable executable instructions and data, and the memory stores machine/computer-readable executable instructions and data including one or more applications, including a client component of the dispatch management application 108A. The processor 202 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The client computing device 102 uses the dispatch management application 108A to transmit data and messages and receive messages, data, and/or resources from the one or more server computing devices 104. The dispatch management application 108A provides an interface for a service provider user to view and fulfill a customer request for a vehicle 110 to rent for a period of time to be delivered to a particular location and return the vehicle to an appropriate parking location.

In order to obtain access to protected resources associated with the server computing device 104, e.g., resources stored in the database 106, the client computing device 102 optionally may transmit a request or other communication, such as with a representation of a username and a password, to the server computing device 104 using lightweight directory access protocol (LDAP), HTTP, hypertext transport protocol secure (HTTPS) and/or other protocols. The request may be a LDAP request, a representational state transfer (REST) request, a Simple Object Access Protocol (SOAP) request, or another type of request. The server computing device 104 optionally verifies the username and password and transmits a response or other communication to the client computing device 102 or otherwise grants access to the client computing device to create and view data. The server computing device 104 may transmit an HTTP response, an HTTPS response, a LDAP response, a REST response, a SOAP response, and/or another type of response.

The username and password may be encrypted by the client computing device 102 using transport layer security (TLS), secure sockets layer (SSL), and/or other encryption protocols. The username and password may be encrypted using a cryptographic hash function (e.g., SHA-1, MD5, and others) to determine a hash-based message authentication code (HMAC) (hash-based message authentication code). In one example, “username.password” is encrypted using the cryptographic hash function. This cryptographic hash function allows the username and password to be verified and authenticated by the server computing device 104 without directly sending the username and password to the server computing device via the communications network 112.

The dispatch management application 108A may be a component of an application and/or service executable by the client computing device 102. For example, the dispatch management application 108A may be a single unit of deployable executable code. The dispatch management application 108A may be one application and/or a suite of applications. According to an example embodiment, the dispatch management application 108A may be a native application or a mobile application (e.g., an app) downloaded from a digital distribution application platform that allows users to browse and download applications developed with mobile software development kits (SDKs) including the App Store and GOOGLE PLAY® among others. The app may be installed on the client computing device 102, which may have the iOS operating system or an ANDROID™ operating system, among other operating systems. The dispatch management application 108A communicates messages to the server computing device 104 and receives messages from the server computing device, e.g., HTTP requests and corresponding HTTP responses. The responses may comprise requested content.

The client computing device 102 further includes a display 220 and an input device 222. The display 220 is used to display visual components of the dispatch management application 108A, such as at a user interface. In one example, the user interface may display a user interface of the dispatch management application 108A, and a representation of the requested resources received from the server computing device 104. The display 220 can include a cathode-ray tube display, a liquid-crystal display, a light-emitting diode display, a touch screen display, and/or other displays. The input device 222 is used to interact with the dispatch management application 108A or otherwise provide inputs to the client computing device 102 and may include a mouse, a keyboard, a trackpad, and/or the like. The input device 222 may be included within the display 220 if the display is a touch screen display. The input device 222 allows a user of the client computing device 102 to manipulate the user interface of the dispatch management application 108A or otherwise provide inputs to be transmitted to the server computing device 104.

The client computing device 102 may include an imaging device 224, e.g., a camera for capturing video and/or still images and photographs, an optional sound device for providing audio output that may be associated with a notification provided by the server computing device 104 and received by the dispatch management application 108A or other user interface or application and an optional vibration motor for providing vibration feedback that may be associated with a notification provided by the server computing device 104 and received by the dispatch management application 108A. The client computing device 102 also may include a global positioning system (GPS) device 226 for obtaining a current location of the client computing device 102.

The client computing device 102 includes computer readable media (CRM) 204 in memory on which the dispatch management application 108A or other user interface or application is stored. The computer readable media may include volatile media, nonvolatile media, removable media, non-removable media, and/or another available medium that can be accessed by the processor 202. By way of example and not limitation, the computer readable media comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The dispatch management application 108A includes a user account module 208 for creating a user account for use with the vehicle dispatch system 100. The user account module 208 receives user account information including username information, e.g., ServiceProviderUser, password information, e.g., 1234Secret, and contact information such as an email address, among other information such as biometric information for the user. The biometric information may include a representation of a fingerprint of the user. The user account module 208 receives input from a user of the dispatch management application 108A and transmits the user account information to the server computing device 104 to create the user account for use with the vehicle dispatch system 100.

The dispatch management application 108A further includes an identity verification module 210 for verifying an identity of a user of the dispatch management application 108A. After the user creates an account, the user may provide identity information including a first name, a last name, a physical address, an identification number/information such as a driver's license number, a passport number, and/or a social security number, and driver's license information, among other information.

As an example, the user may capture a front photograph of their driver's license and a back photograph of their driver's license using the imaging device 224. The identity verification module 210 and/or the server computing device 104 may determine the first name, the last name, the physical address, the driver's license number or another identification number, and a photograph of the user by performing image analysis on the front photograph and the back photograph. The identity verification module 210 may transmit the identity information to the server computing device 104. The server computing device 104 may store a representation of the identity information in the database 106. The server computing device 104 may confirm the identity of the user before the user is permitted to operate a vehicle 110.

The dispatch management application 108A further includes a location delivery module 212 for obtaining a current location of the client computing device 102 and by association, the location of the service provider user. In an example embodiment, the service provider user can indicate whether the service provider user is available to service vehicle delivery and return requests from customers. The service provider user may select a user interface element such as a slider that indicates whether the service provider is available or not available. If the service provider user is available, then the location delivery module 212 uses the GPS device 226 and/or network services to determine a current location of the client computing device 102. The location delivery module 212 transmits the current location of the client computing device 102 to the server computing device 104 and the server computing device stores the current location of the service provider user in the database 106. If the service provider is available, the location delivery module 212 may regularly transmit the current location of the client computing device 102 at a particular interval of time, e.g., every X seconds. The particular interval of time may be dynamically modified based on the real-time change in the location of the client computing device 102. For example, the client computing device 102 may obtain the location of the client computing device every two minutes if the client computing device 102 is stationary and may obtain the location of the client computing device every second if the client computing device is not stationary and traveling at a high rate of speed, e.g., located within a vehicle. If the service provider user is not available, then the current location of the client computing device 102 is not obtained by the location delivery module 212.

The dispatch management application 108A further includes a mission communication module 214 for receiving information regarding a mission from the server computing device 104 and transmitting information regarding the mission to the server computing device 104. As an example, the server computing device 104 may determine that there is a new mission associated with an event and any associated dependent events, e.g., delivery or retrieval of a particular vehicle. The server computing device 104 may determine that a particular service provider user has a current location that is closest to the delivery location or retrieval location of the particular vehicle. In addition, the particular service provider may have a highest ranking among available service providers. The ranking is determined by the server computing device 104 and described further herein. The server computing device 104 may transmit information associated with the mission to the client computing device 102. The client computing device 102 may display a notification that indicates that there is a new mission available. The notification may request that the service provider user accept or decline the mission. If the service provider user accepts the mission, then the client computing device 102 may display additional information associated with the mission such as vehicle information, a booking identifier, an address, and time information associated with delivery or retrieval such as an expected time window for the customer. In addition, the client computing device 102 may display on the display 220 step-by-step instructions regarding how to complete the event including real-time turn-by-turn navigation directions to the location of the vehicle or a delivery location.

The dispatch management application 108A further includes a user interface module 216 for displaying a user interface on the display 220. As an example, the user interface module 218 generates a native and/or web-based graphical user interface (GUI) that accepts input and provides output viewed by users of the client computing device 102. The client computing device 102 may provide realtime automatically and dynamically refreshed dispatch management information. The user interface module 216 may send data to other modules of the dispatch management application 108A of the client computing device 102, and retrieve data from other modules of the dispatch management application 108A of the client computing device 102 asynchronously without interfering with the display and behavior of the user interface displayed by the client computing device 102.

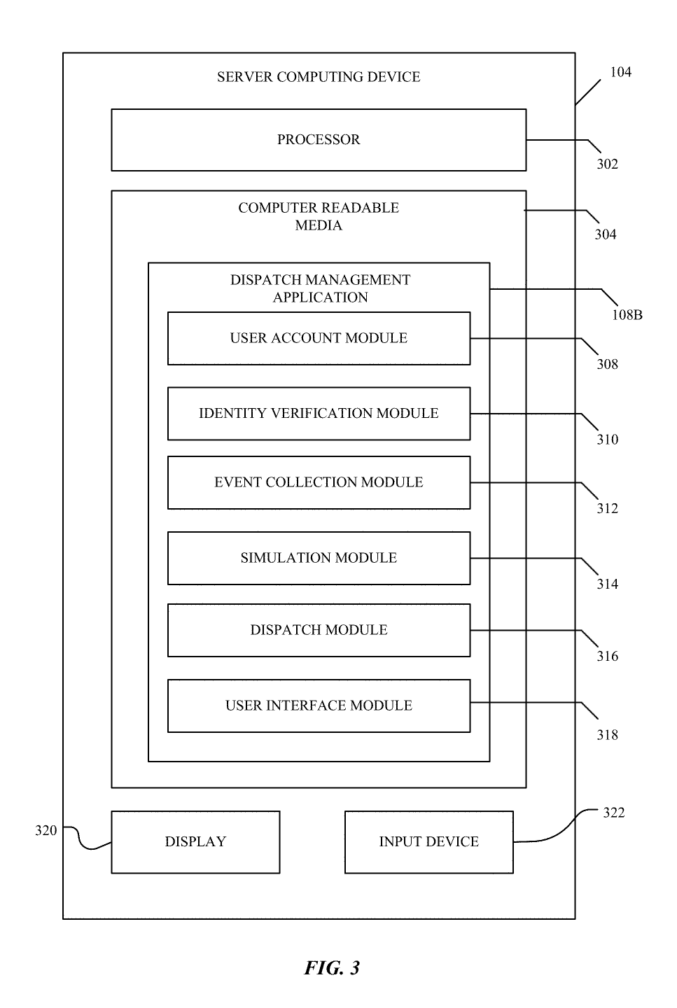

FIG. 3 illustrates a block diagram of the server computing device 104 according to an example embodiment. The server computing device 104 may be a computer having a processor 302 and memory, such as a server, laptop, desktop, tablet computer, mobile computing device (e.g., a smartphone), or a dedicated electronic device having a processor and memory. The one or more processors 302 process machine/computer-readable executable instructions and data, and the memory stores machine/computer-readable executable instructions and data including one or more applications, including a server component of the dispatch management application 108B. The processor 302 and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The server computing device 104 may include an optional display 320 and an optional input device 322. The display 320 displays visual components of the server component of the dispatch management application 108B, such as at a user interface, if applicable. The display 320 can include a cathode-ray tube display, a liquid crystal display, a light-emitting diode display, a touch screen display, and/or other displays. The input device 322 is used to interact with the server component of the dispatch management application 108B and may include a mouse, a keyboard, a trackpad, and/or the like. The input device 322 may be included within the display 320 if the display is a touch screen display. The input device 322 allows a user of the server computing device 104 to manipulate the user interface of the dispatch management application 108B and make adjustments to the dispatch management application 108B.

The server computing device 104 includes computer readable media (CRM) 304 in memory on which the server component of the dispatch management application 108B is stored. The computer readable media 304 may include volatile media, nonvolatile media, removable media, non-removable media, and/or another available medium that can be accessed by the processor 302. By way of example and not limitation, the computer readable media 304 comprises computer storage media and communication media. Computer storage media includes non-transitory storage memory, volatile media, nonvolatile media, removable media, and/or non-removable media implemented in a method or technology for storage of information, such as computer/machine-readable/executable instructions, data structures, program modules, or other data. Communication media may embody computer/machine-readable/executable instructions, data structures, program modules, or other data and include an information delivery media or system, both of which are hardware.

The dispatch management application 108B includes a user account module 308 for receiving, storing, verifying, and resetting information associated with accounts for using the dispatch management system 100. The information associated with the accounts may include username and password information, address information, payment/bank information, and contact information, among other information. When a user, including a service provider that first uses the dispatch management application 108B, the user is asked to create a user account. The user may input a username such as an email address and a password, among other information, and transmit this information to the dispatch management application 108B. The user account module 308 stores a representation of this information in the database 106. After the user account is created, when the client computing device 102 opens the dispatch management application 108A, a representation of the username and a representation of the password may be transmitted to the server computing device 104. The server computing device 104 verifies the username and password upon receipt and determines whether the user is an authorized user of the dispatch management application 108B. If the user is not an authorized user, then they may be denied further access to the dispatch management application 108B.

The user account module 308 may provide an interface for resetting password information associated with a particular user account. If a user is unable to provide a correct password or other authentication information after a particular number of incorrect attempts or the password or other authentication information is unknown, the user account module 308 may send a “Forgot Password” message to the vehicle dispatch application 108A and display a “Forgot Password” user interface. The user may submit a request that the server computing device 104 reset the password associated with the user account and send an email to an email address associated with the user account including a one-time use URL that when selected, displays a web-based user interface allowing the user to reset their password and create a new password for use with the user account. The user account module 308 also may reset the password in other ways.

In addition, over time the user account module 308 may store history information associated with each event associated with the service provider user including a vehicle 110 rented for the vehicle rental reservation, a vehicle provider/supplier/owner for the vehicle rental reservation, date/time of the vehicle rental reservation, a vehicle delivery location, a vehicle delivery location, mileage driven by the service provider, information associated with where the vehicle traveled during the vehicle rental information that may be displayed on a map, velocity of the vehicle during the vehicle rental reservation, service provider performance information (e.g., a rating, timeliness), and a cost of the rental, among other information. The user account module 308 may use this history information to provide performance evaluations for service providers.

The dispatch management application 108B additionally includes an identity verification module 310 to verify the identity of users including third party providers that deliver vehicles 110 and pick up vehicles 110. Before a user is able to operate a vehicle 110, the identity verification module 310 verifies the identity of the user using the identity information including the first name, the last name, the physical address, the identification number such as the social security number or driver's license number, and the driver's license information, among other information. The identity information may be obtained from photographs of the driver's license transmitted from the client computing device 102. For example, the identity verification module 310 may determine the first name, the last name, the physical address, the driver's license number, and a photograph of the user by performing image analysis including optical character recognition on the front photograph of the driver's license and the back photograph of the driver's license.

The dispatch management application 108B further includes an event collection module 312 for collecting a subset of a list of events associated with the dispatch management system 100 at a regular interval of time over a particular future period of time such as a first period of time, a second period of time, a third period of time, etc. A subset of the events may occur during the next three hours and another portion of the events may occur after the next three hours. As an example, the event collection module 312 may obtain the list of events including upcoming vehicle deliveries and vehicle retrievals from the database 106 that are to occur during the particular period of time, e.g., the next three hours at 11:00 a.m., the next three hours at 11:03 a.m., the next three hours at 11:06 a.m., etc. The event collection module 312 may obtain the list of events from the memory of the server computing device 104 and/or the database 106. The event collection module 312 may order the list of events based on chronological order or based on another type of order.

The dispatch management application 108B additionally includes a simulation module 314 for determining each available service provider and each event in the subset of the list of events at a particular time, and assigning a particular available service provider to each event in the subset of the list of events. In one example, the simulation module 314 may assign each particular available service provider to an event in the subset of the list of events based on the current location of the client computing device 102 of the particular service provider. In other words, the simulation module 314 may assign a first available service provider to a first event, a second available service provider to a second event, a third available service provider to a third event, and so on. The current location of the client computing device 102 of the particular service provider may be closer to a location associated with the event than all other current locations of other client computing devices of other service provider users. The current location of the client computing device 102 may have a lowest distance or a lowest time to travel between the current location of the particular available service provider and the location associated with the event in the subset of the list of events. The simulation module 314 may make assignments of each particular available service provider based on other factors such as vehicle availability, and traffic information, among other factors. The simulation module 314 may continue to assign events until all events have an assigned service provider and/or there are no available service providers remaining.

When the simulation is complete, the simulation module 314 may begin the simulation again by assigning a first available service provider to a first event, a second available service provider to a second event, a third available service provider to a third event, and so on. However, in this simulation, the simulation module may assign the second closest service provider to the first event. The simulation module 314 may determine a total distance traveled by all service providers for each simulation and may discard simulations where the total distance traveled by service providers exceeds the best simulation. Once the simulation module 314 has run through all possible configurations of service provider assignments, the simulation module may select the simulation with the least distance or minimum distance traveled overall or the simulation with the least expected travel time overall as an optimum solution.

The simulation module 314 may generate the optimum solution for assigning each available service provider to each event in the subset of the list of events. Each service provider user that is selected for an event is deemed to be the best service provider for that particular event based on the current location of the client computing device 102 in addition to other factors including ranking information. Each service provider has a ranking among all service providers in a city or metropolitan location that is based on performance in the city or metropolitan location. The ranking is determined based on a score awarded to each service provider. The score is based on a number of weighted factors. Each of the weighted factors may be weighted from −1.0 to 1.0. The weighted factors may include: timeliness (how often the service provider is late), accepted rental/service requests (the proportion of rental/service requests that a service provider accepts/declines, cancellations (the number of jobs that a service provider cancels once the job is underway), and customer rating (the aggregate of all of the ratings that customers give the service provider), among others. When the simulation is complete, the simulation module 314 may store information associated with the simulation in the memory of the server 104 and/or the database 106. The simulation module 314 may perform the simulation at a particular interval of time, e.g., every N seconds.

In addition to assigning the event, the simulation module 314 also may identify or create dependent events that are to be completed along with the event. These dependent events also are assigned to the particular available service provider. As an example, if the event includes delivery of a vehicle to a customer at a particular location, the simulation module 314 may create a dependent event that includes collecting the vehicle from a vehicle provider or from another customer that requested that their vehicle be retrieved at a time that precedes the delivery of the vehicle. The other customer that requested that the vehicle be retrieved should have a same or similar vehicle as requested by the customer. As another example, if the event includes retrieval of a vehicle from a customer at a particular location, the simulation module 314 may create a dependent event that includes delivering the vehicle to a vehicle provider or a next customer that has a vehicle delivery request that is after the retrieval of the vehicle. In a further example, if the event includes a delivery of a vehicle to a customer at a particular location, the simulation module 314 may create a dependent event that includes traveling to a vehicle cleaning facility (e.g., a car wash) to clean to the vehicle and/or a refueling/charging station before the vehicle is delivered to the particular location. The particular service provider will be deemed unavailable for the time that it will take to complete the event and any associated dependent events.

The dispatch management application 108B further includes a dispatch module 316 for dispatching a particular service provider user to service a particular event. After the simulation is determined by the simulation module 314, the dispatch module 316 sends event information as a mission communication to the mission communication module 214 of the client computing device 102, beginning with the event that is due soonest and continuing until the end of the particular period of time such as three hours. The dispatch module 316 continues to send the event information to client computing devices 102 associated with each event in the list of events as determined by the simulation module 314. The dispatch module 316 confirms whether each service provider user accepts or declines the mission associated with the event. If the service provider user declines the mission, then the dispatch module 314 informs the simulation module 314 that the mission was not accepted and the event is added back into the list of events and is serviced in a next simulation of events.

When an event is completed, the service provider user may transmit information associated with the completion of the event to the server computing device 104 and the server computing device 104 may determine that the event is completed. The server computing device 104 may store information associated with the completed event in memory and/or the database 106.

The dispatch management application 108B includes a user interface module 318. The user interface module 318 receives requests or other communications from the client computing devices 102 and transmits a representation of requested information, user interface elements, and other data and communications to the client computing device 102 for display on the display 220. As an example, the user interface module 318 generates a native and/or web-based graphical user interface (GUI) that accepts input and provides output by generating content that is transmitted via the communications network 112 and viewed by a user of the client computing device 102. The user interface module 318 may provide realtime automatically and dynamically refreshed information to the user of the client computing device 102 using Java, Javascript, AJAX (Asynchronous Javascript and XML), ASP.NET, Microsoft .NET, and/or node.js, among others. The user interface module 318 may send data to other modules of the dispatch management application 108B of the server computing device 104, and retrieve data from other modules of the dispatch management application 108B of the server computing device 104 asynchronously without interfering with the display and behavior of the dispatch management application 108A displayed by the client computing device 102. As an example, data may be retrieved using XMLHttpRequest objects or using WebSockets.

The vehicle 110 may include a computer having a processor and memory, or a dedicated electronic device having a processor and memory. The one or more processors process machine/computer-readable executable instructions and data, and the memory stores machine/computer-readable executable instructions and data including one or more applications, including components that may communicate with the dispatch management application 108A/108B. The processor and memory are hardware. The memory includes random access memory (RAM) and non-transitory memory, e.g., a non-transitory computer-readable storage medium such as one or more flash storages or hard drives. The non-transitory memory may include any tangible computer-readable medium including, for example, magnetic and/or optical disks, flash drives, and the like. Additionally, the memory may also include a dedicated file server having one or more dedicated processors, random access memory (RAM), a Redundant Array of Inexpensive/Independent Disks (RAID) hard drive configuration, and an Ethernet interface or other communication interface, among other components.

The vehicle 110 may be autonomous or partially autonomous. For example, the vehicle 110 may operate without a service provider while in an autonomous mode and may determine a current state of the vehicle and its environment, determine predicted behavior of at least one other vehicle in the environment, determine obstacles in the environment including pedestrians, animals, and other objects, and control the vehicle 110.

Additionally, the vehicle 110 may include subsystems such as a sensor system, a control system, a propulsion system, a communication system, a power supply, a user interface display, and other systems. In one example, the vehicle 110 may communicate with the client computing device 102 and/or the server computing device 104. The vehicle 110 may connect with the client computing device 102 using the communications network 112 and/or may connect using Bluetooth®. These subsystems may be interconnected via a bus or another connector. The propulsion system may include components to provide powered motion for the vehicle 110. The propulsion system may include an engine and/or a motor. The engine and/or the motor may include an internal combustion engine, an electric motor, or other types of engines and/or motors.

In one example, the vehicle 110 may receive location information including a delivery location or a return location from the server computing device 104 and determine a particular route to the delivery location or the return location. If the vehicle is an autonomous vehicle or a partially autonomous vehicle, the vehicle 110 may travel to the delivery location or the return location.

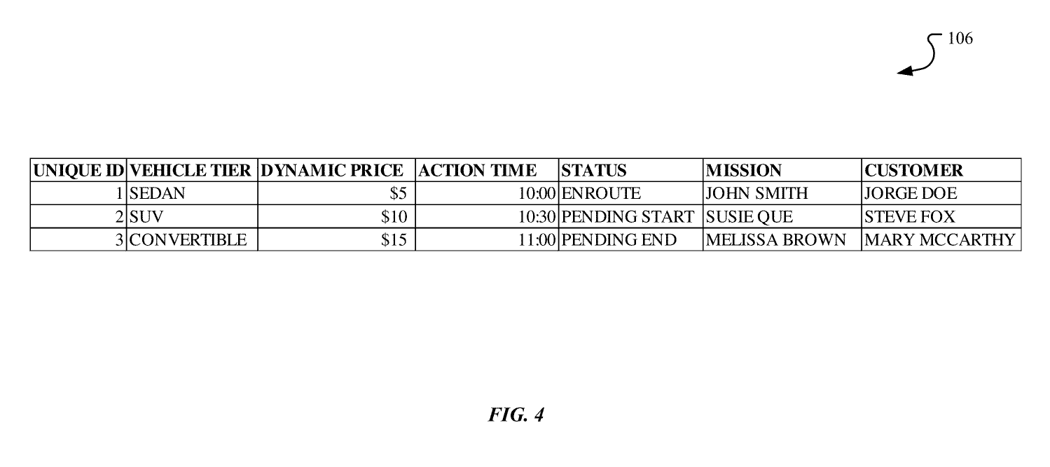

FIG. 4 illustrates an example table of the database 106 of the vehicle dispatch system 100 according to an example embodiment. As shown in FIG. 4, each row of the table may store information regarding a vehicle 110 of the dispatch management system 100. FIG. 4 shows that the database 106 may store a unique identifier (ID) that represents each vehicle 110, a vehicle tier for each vehicle 110, a dynamic price for each vehicle 110, a time that an event was received by the server computing device 104, a status of each event, a mission assignment name for a service provider for each event, and a customer of each event, among other information. Other information may be stored in the database 106 such as a location of each vehicle 110 and a location of each client computing device 102.

Each event (or mission) has a price that is paid to the service provider upon completion of the mission. The service provider may view the price on the client computing device 102 before accepting the mission. If service providers are not accepting a certain mission, or service providers are not accepting missions in a certain area, the system 100 can increase the price of those missions. The price can be increased manually by a “dispatch manager,” or the price can be automatically adjusted based on certain rules provided by the server computing device 104. For example, if the number of available service providers within x miles of a hub (the parking lot where vehicles are located) falls below a given number, y, the system 100 will increase the price of all missions that either start or finish at that hub by a given percentage, e.g., 10%. The system 100 can keep increasing the price until the number of available service providers within the given radius exceeds the given number y.

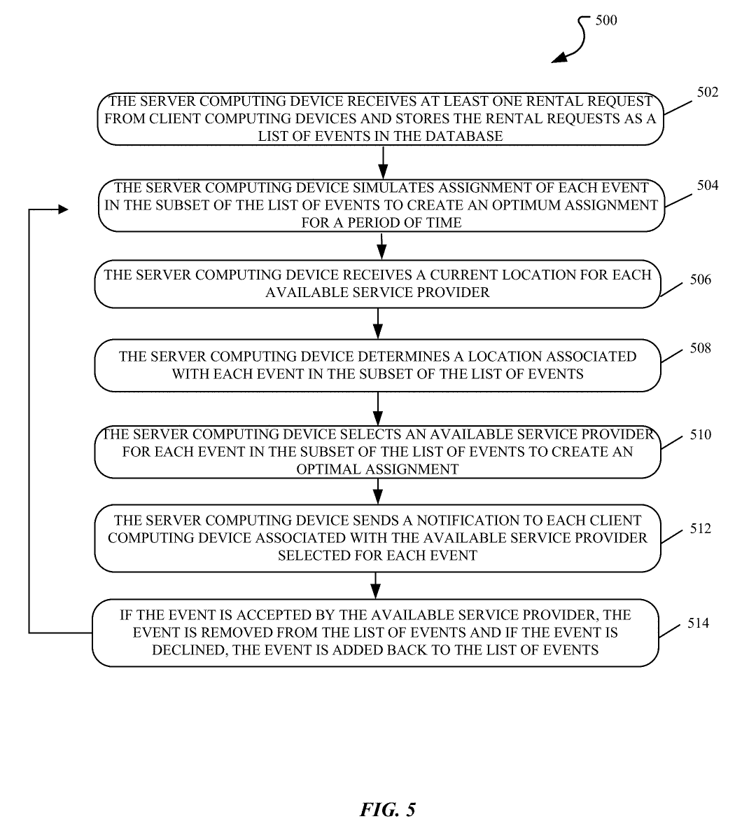

FIG. 5 illustrates a flowchart of a process for optimally simulating a list of events according to an example embodiment. In a first step 502, the server computing device 104 receives at least one rental request from client computing devices and stores the rental requests as a list of events in the database 106. As noted herein, each event may have dependent events, e.g., refueling, recharging, or washing events. The rental requests may be vehicle pickup requests and/or vehicle return requests and may have associated event data that is received such as a date, a time, a location of the request, a type of vehicle requested, a vehicle company provider, and a name of a customer, among other information.

Next, in step 504, the server computing device 104 simulates assignment of each upcoming event in the subset of the list of events for a particular future period of time, e.g., three hours. The server computing device 104 may perform the simulation every N seconds, N minutes, etc. In one example, the server computing device 104 may perform the simulation every forty-five seconds, every three minutes, etc. In 506, the server computing device 104 may request that each available service provider transmit their current location to the server computing device 104. The location delivery module 212 of the client computing device 102 may obtain the current location of the client computing device 102 and transmit the current location to the server computing device 104. In 508, the server computing device 104 may determine a location associated with each rental request that is stored in the database 106, e.g., a location to deliver a vehicle 110 and/or a location to retrieve a vehicle 110.

Next, in step 510, the server computing device 104 may select an available service provider for each upcoming event in the subset of the list of events for the particular period of time. The service provider may be selected based on the current location of the service provider and the location associated with the event. The service provider may have the lowest distance or the lowest time to travel between the current location of the service provider and the location associated with the event. The server computing device 104 may continue to select an available service provider for each event until all events have an assigned service provider or there are no available service providers. At this point, the assignment of the events may represent an optimum simulation or most efficient simulation where events are optimally assigned to service providers.

In step 512, the server computing device 104 sends a notification and/or a message to each client computing device associated with the available service provider that is selected for each event that is sent as a mission. In one example, the notification may be a push notification that may be sent to the dispatch management application 108A of the client computing device 102. The user interface of the dispatch management application 108A may display interface elements such as details about the mission (e.g., a location of a vehicle) and buttons that allow the service provider to accept or decline the mission. In another example, the notification may be an email, a text message, a telephone call, or another type of notification.

In step 514, the server computing device 104 receives a response to the notification from the client computing device 102. The available service provider may either accept the mission or decline the mission. If the mission is accepted by the available service provider, then the event is accepted and removed from the list of events. If the mission is declined by the available service provider, then the event is declined and the event is added back to the list of events. At this point, the system may begin the simulation again in step 504 by simulating assignment of each upcoming event in the subset of the list of events for the upcoming particular period of time.

As each event is accepted, the server computer 104 may store service provider information in the database 106. The notifications regarding the particular tasks may include instructions on how to complete the event. This information may be displayed by the particular service provider client computer 102. The service provider may confirm completion of the event using the particular service provider client computer 102 and may send status updates to the server computer 104. The server computer 104 may store information associated with the status updates in the database 106 and track progress toward completion.

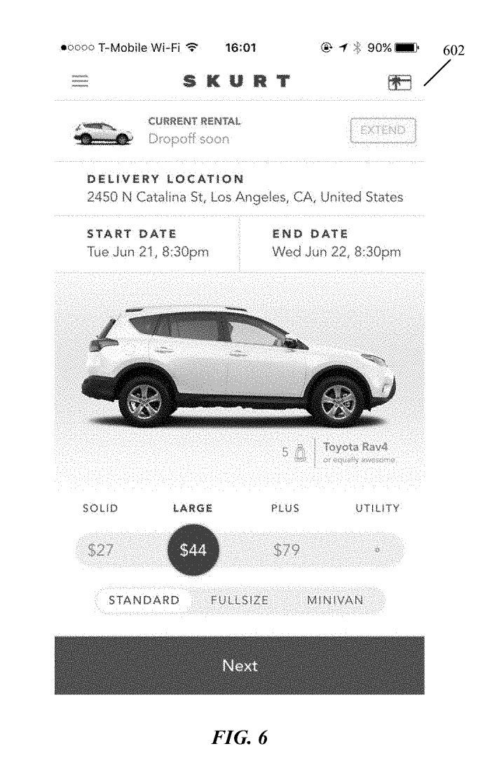

FIG. 6 shows a screenshot 602 of a customer user client application where the user has made a rental request and selected a particular vehicle for a rental that is to be delivered to a particular location for a rental duration having a start date and an end date. The rental request includes this event data that is stored in the database 106.

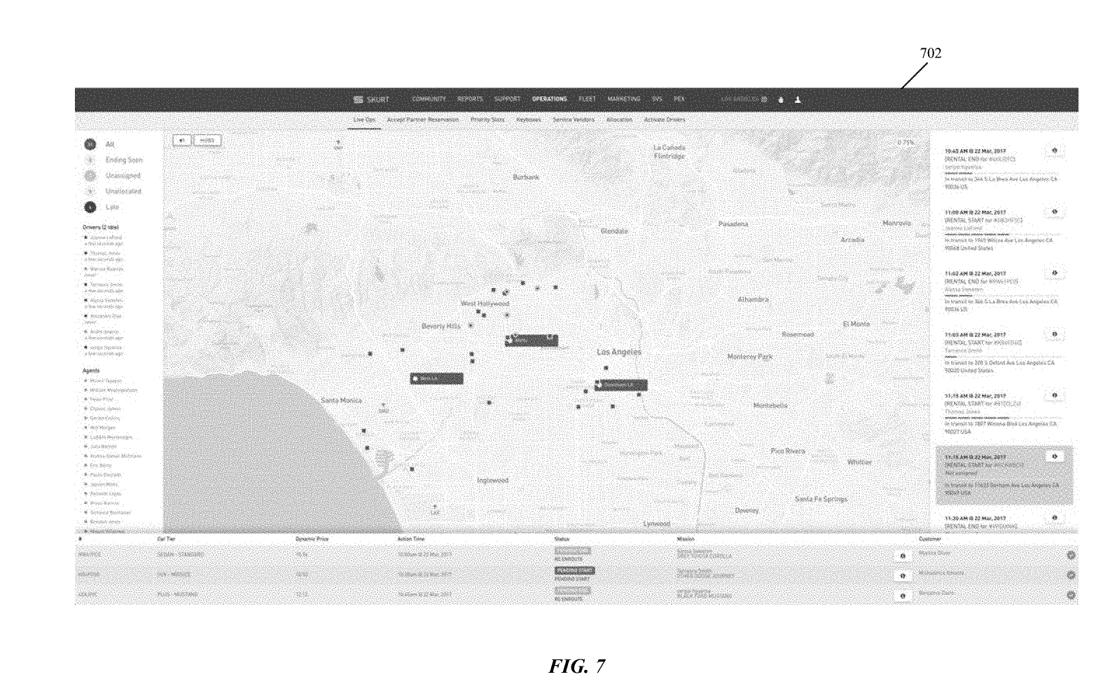

FIG. 7 shows a screenshot 702 of a user interface of the server component of the dispatch management application 108B displayed on the display 320 of the server computing device 104. As shown in FIG. 7, the user interface includes a map section that displays a user interface element that represents vehicles that are currently being rented and vehicles that are not currently being rented. The user interface also indicates a list of service providers and their current availability. In addition, the user interface includes a section that shows information about the list of events on the bottom and the right side.

In particular, the left panel of the screenshot 702 shows metrics summarizing a number of current rental/service requests including how many rental/service requests have been accepted by providers, how many have been dispatched but not accepted, and how many service requests are late. A list of service providers is shown below the metrics. A dot next to a service in a first color (e.g., green) may represent that the service provider is available. A dot in a second color (e.g., red) may represent that the service provider is currently on a mission.

Service providers may be represented by circular dots on the map. A dot in a first color may indicate that the service provider is busy. A dot in a second color may indicate that the service provider is available. An end location, e.g., the final destination, of each rental/service request may be represented by a square or another user interface element. In addition, hubs (parking locations for vehicles) may be indicated on the map.

The right panel of the screenshot 702 displays a list of current missions with relevant information including reservation number, deadline time, location, assigned service provider, mission progress, and other information. Each mission may be selected to reveal more information such as when the mission was dispatched, which providers declined the mission, when each stage of the mission was completed, the price, whether the mission price was increased and by how much, among other information. Dispatch managers can also use this panel to cancel a mission, re-dispatch a mission, or override and directly assign a mission to a service provider.

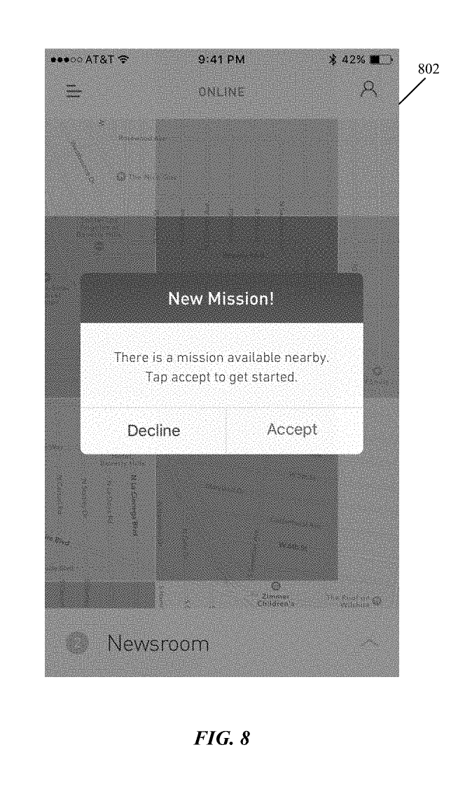

FIG. 8 shows a screenshot 802 of a user interface of the client component of the dispatch management application 108A displayed on the display 220 of the client computing device 102. As shown in FIG. 8, the client computing device 102 has received a notification that indicates that there is a new mission available. The service provider may select whether to accept or decline the mission. If the service provider accepts the mission, then the event will be removed from the list of events and the service provider will be assigned to the mission. If the service provider declines the mission, then the event will be added back into the list of events for the next simulation.

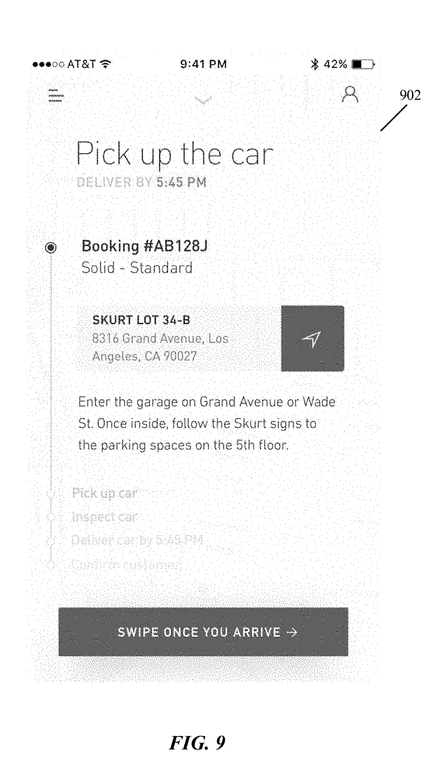

FIG. 9 shows another screenshot 902 of a user interface of the client component of the dispatch management application 108A displayed on the display 220 of the client computing device 102. As shown in FIG. 9, the service provider has accepted a particular mission and the display 220 shows details regarding the mission. The details include a booking identification number, a vehicle type, a location of the vehicle, a user interface element that when selected opens a mobile deep link or a universal link, e.g., a uniform resource identifier to a map application to provide turn-by-turn navigation directions to the location of the vehicle 110, and a user interface element that is to be selected when the service provider arrives at the location of the vehicle. As an example, the deep link may be https://maps.google.com or https://maps.apple.com, among others.

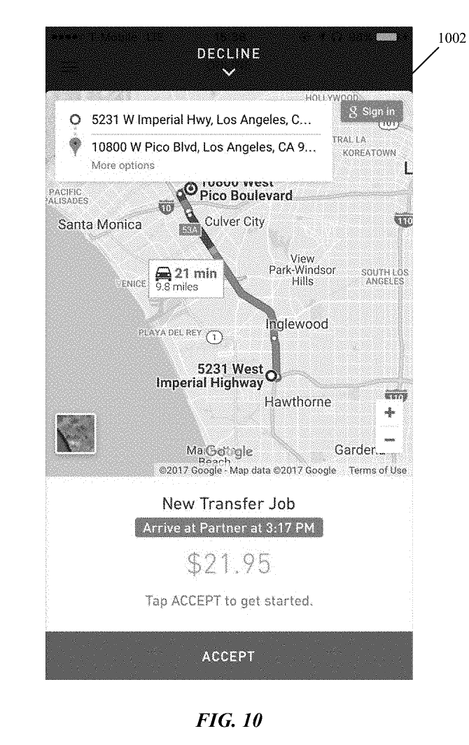

FIG. 10 shows a screenshot 1002 of a user interface of the client component of the dispatch management application 108A displayed on the display 220 of the server computing device 104. As shown in FIG. 10, the service provider may accept the mission shown on the display 220 by selecting the user interface element labeled “Accept.” When the service provider accepts the mission, the client computing device 102 provides turn-by-turn navigation directions to the location of the vehicle 110.

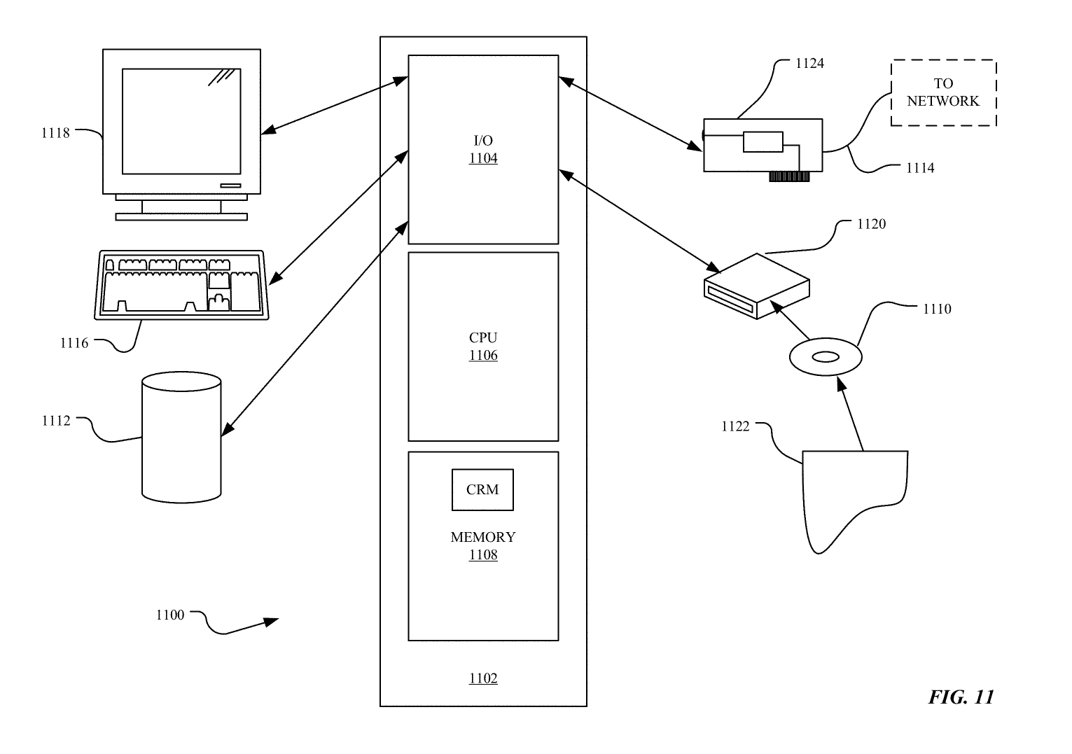

FIG. 11 illustrates an example computing system 1100 that may implement various systems, such as the client computing device 102, the server computing device 104, the vehicle 110, and the methods discussed herein, such as process 500. A general purpose computer system 1100 is capable of executing a computer program product to execute a computer process. Data and program files may be input to the computer system 1100, which reads the files and executes the programs therein such as the client component of the dispatch management application 108A and the server component of the dispatch management application 108B. Some of the elements of a general purpose computer system 1100 are shown in FIG. 11 wherein a processor 1102 is shown having an input/output (I/O) section 1104, a central processing unit (CPU) 1106, and a memory section 1108. There may be one or more processors 1102, such that the processor 1102 of the computer system 1100 comprises a single central-processing unit 1106, or a plurality of processing units, commonly referred to as a parallel processing environment. The computer system 1100 may be a conventional computer, a server, a distributed computer, or any other type of computer, such as one or more external computers made available via a cloud computing architecture. The presently described technology is optionally implemented in software devices loaded in memory 1108, stored on a configured DVD/CD-ROM 1110 or storage unit 1112, and/or communicated via a wired or wireless network link 1114, thereby transforming the computer system 1100 in FIG. 11 to a special purpose machine for implementing the described operations.

The memory section 1108 may be volatile media, nonvolatile media, removable media, non-removable media, and/or other media or mediums that can be accessed by a general purpose or special purpose computing device. For example, the memory section 1108 may include non-transitory computer storage media and communication media. Non-transitory computer storage media further may include volatile, nonvolatile, removable, and/or non-removable media implemented in a method or technology for the storage (and retrieval) of information, such as computer/machine-readable/executable instructions, data and data structures, engines, program modules, and/or other data. Communication media may, for example, embody computer/machine-readable/executable, data structures, program modules, algorithms, and/or other data. The communication media may also include an information delivery technology. The communication media may include wired and/or wireless connections and technologies and be used to transmit and/or receive wired and/or wireless communications.

The I/O section 1104 is connected to one or more user-interface devices (e.g., a keyboard 1116 and a display unit 1118), a disc storage unit 1112, and a disc drive unit 1120. Generally, the disc drive unit 1120 is a DVD/CD-ROM drive unit capable of reading the DVD/CD-ROM medium 1110, which typically contains programs and data 1122. Computer program products containing mechanisms to effectuate the systems and methods in accordance with the presently described technology may reside in the memory section 1104, on a disc storage unit 1112, on the DVD/CD-ROM medium 1110 of the computer system 1100, or on external storage devices made available via a cloud computing architecture with such computer program products, including one or more database management products, web server products, application server products, and/or other additional software components. Alternatively, a disc drive unit 1120 may be replaced or supplemented by a floppy drive unit, a tape drive unit, or other storage medium drive unit. The network adapter 1124 is capable of connecting the computer system 1100 to a network via the network link 1114, through which the computer system can receive instructions and data. Examples of such systems include personal computers, Intel or PowerPC-based computing systems, AMD-based computing systems and other systems running a Windows-based, a UNIX-based, or other operating system. It should be understood that computing systems may also embody devices such as Personal Digital Assistants (PDAs), mobile phones, tablets or slates, multimedia consoles, gaming consoles, set top boxes, etc.

When used in a LAN-networking environment, the computer system 1100 is connected (by wired connection and/or wirelessly) to a local network through the network interface or adapter 1124, which is one type of communications device. When used in a WAN-networking environment, the computer system 1100 typically includes a modem, a network adapter, or any other type of communications device for establishing communications over the wide area network. In a networked environment, program modules depicted relative to the computer system 1100 or portions thereof, may be stored in a remote memory storage device. It is appreciated that the network connections shown are examples of communications devices for and other means of establishing a communications link between the computers may be used.

In an example implementation, source code executed by the client computing device 102, the server computing device 104, the vehicle 110, a plurality of internal and external databases, source databases, and/or cached data on servers are stored in the database 106, memory of the client computing device 102, memory of the server computing device 104, memory of the vehicle, or other storage systems, such as the disk storage unit 1112 or the DVD/CD-ROM medium 1110, and/or other external storage devices made available and accessible via a network architecture. The source code executed by the client computing device 102, the server computing device 104, and the vehicle 110 may be embodied by instructions stored on such storage systems and executed by the processor 1102.

Some or all of the operations described herein may be performed by the processor 1102, which is hardware. Further, local computing systems, remote data sources and/or services, and other associated logic represent firmware, hardware, and/or software configured to control operations of the dispatch management system 100 and/or other components. Such services may be implemented using a general purpose computer and specialized software (such as a server executing service software), a special purpose computing system and specialized software (such as a mobile device or network appliance executing service software), or other computing configurations. In addition, one or more functionalities disclosed herein may be generated by the processor 1102 and a user may interact with a Graphical User Interface (GUI) using one or more user-interface devices (e.g., the keyboard 1116, the display unit 1118, and the user devices 1104) with some of the data in use directly coming from online sources and data stores. The system set forth in FIG. 11 is but one possible example of a computer system that may employ or be configured in accordance with aspects of the present disclosure.

In the present disclosure, the methods disclosed may be implemented as sets of instructions or software readable by a device. Further, it is understood that the specific order or hierarchy of steps in the methods disclosed are instances of example approaches. Based upon design preferences, it is understood that the specific order or hierarchy of steps in the method can be rearranged while remaining within the disclosed subject matter. The accompanying method claims present elements of the various steps in a sample order, and are not necessarily meant to be limited to the specific order or hierarchy presented.

The described disclosure may be provided as a computer program product, or software, that may include a non-transitory machine-readable medium having stored thereon executable instructions, which may be used to program a computer system (or other electronic devices) to perform a process according to the present disclosure. A non-transitory machine-readable medium includes any mechanism for storing information in a form (e.g., software, processing application) readable by a machine (e.g., a computer). The non-transitory machine-readable medium may include, but is not limited to, magnetic storage medium (e.g., floppy diskette), optical storage medium (e.g., CD-ROM); magneto-optical storage medium, read only memory (ROM); random access memory (RAM); erasable programmable memory (e.g., EPROM and EEPROM); flash memory; or other types of medium suitable for storing electronic executable instructions.

The description above includes example systems, methods, techniques, instruction sequences, and/or computer program products that embody techniques of the present disclosure. However, it is understood that the described disclosure may be practiced without these specific details.

It is believed that the present disclosure and many of its attendant advantages will be understood by the foregoing description, and it will be apparent that various changes may be made in the form, construction and arrangement of the components without departing from the disclosed subject matter or without sacrificing all of its material advantages. The form described is merely explanatory, and it is the intention of the following claims to encompass and include such changes.

While the present disclosure has been described with reference to various embodiments, it will be understood that these embodiments are illustrative and that the scope of the disclosure is not limited to them. Many variations, modifications, additions, and improvements are possible. More generally, embodiments in accordance with the present disclosure have been described in the context of particular implementations. Functionality may be separated or combined in blocks differently in various embodiments of the disclosure or described with different terminology. These and other variations, modifications, additions, and improvements may fall within the scope of the disclosure as defined in the claims that follow.

What is claimed is:

1. A system comprising:
a memory; and
at least one processor to:
receive at least one rental request and store the rental request as an event in a list of events in a database;
determine a current location of a client computing device for each available service provider user from a list of service providers;
determine a subset of the list of events that are to occur during a future period of time;
determine a location associated with each event in the subset of the list of events;
select a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events; and
transmit a notification to the client computing device associated with the particular available service provider and receive a confirmation from the client computing device that indicates whether the particular available service provider accepts or declines the particular event in the subset of the list of events.

2. The system of claim 1, the at least one processor further to add the particular event to the list of events when the available service provider declines the particular event.

3. The system of claim 1, the at least one processor further to remove the particular event from the list of events when the available service provider accepts the particular event.

4. The system of claim 1, the at least one processor further to select the particular available service provider from the list of service providers based on vehicle availability associated with a rental request and traffic information.

5. The system of claim 1, the at least one processor further to transmit a deep link to turn-by-turn navigation information to the client computing device from the current location of the particular available service provider to the location associated with the particular event.

6. The system of claim 1, wherein the subset of the list of events is a first subset of the list of events, the future period of time is a first future period of time, and the particular available service provider is a first particular available service provider, the at least one processor further to:
determine the current location of the client computing device for each available service provider user from the list of service providers;
determine a second subset of the list of events that are to occur during a second future period of time;
determine the location associated with each event in the second subset of the list of events;
select a second particular available service provider from the list of service providers for a particular event in the second subset of the list of events based on a ranking of the second particular available service provider and a current location of the second particular available service provider and the location associated with the particular event in the second subset of the list of events; and
transmit the notification to the client computing device associated with the second particular available service provider and receive the confirmation from the client computing device that indicates whether the second available service provider accepts or declines the particular event in the second subset of the list of events.

7. The system of claim 1, the at least one processor further to display on a user interface the current location of each available service provider and the location associated with each event in the list of events.

8. The system of claim 1, wherein the rental request is a vehicle rental request.

9. The system of claim 1, wherein the rental request is one of a vehicle delivery request and a vehicle retrieval request.

10. The system of claim 1, the at least one processor further to select a particular available service provider from the list of service providers for a particular event in the subset of the list of events, the particular available service provider having a lowest time to travel between the current location of the particular available service provider and the location associated with the particular event in the subset of the list of events.

11. The system of claim 1, the at least one processor further to select an optimal assignment of the list of service providers to the subset of the list of events, the optimal assignment having a minimum total distance traveled by the list of service providers.

12. A method comprising:
receiving, by a processor, at least one rental request and storing the rental request as an event in a list of events in a database;
determining, by the processor, a current location of a client computing device for each available service provider user from a list of service providers;
determining, by the processor, a subset of the list of events that are to occur during a future period of time;
determining, by the processor, a location associated with each event in the subset of the list of events;
selecting, by the processor, a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events; and
transmitting, by the processor, a notification to the client computing device associated with the particular available service provider and receiving a confirmation from the client computing device that indicates whether the particular available service provider accepts or declines the particular event in the subset of the list of events.

13. The method of claim 12, further comprising adding the particular event to the list of events when the available service provider declines the particular event.

14. The method of claim 12, further comprising removing the particular event from the list of events when the available service provider accepts the particular event.

15. The method of claim 12, further comprising selecting the particular available service provider from the list of service providers based on vehicle availability associated with a rental request and traffic information.

16. The method of claim 12, further comprising transmitting a deep link to turn-by-turn navigation information to the client computing device from the current location of the particular available service provider to the location associated with the particular event.

17. The method of claim 12, wherein the subset of the list of events is a first subset of the list of events, the future period of time is a first future period of time, and the particular available service provider is a first particular available service provider, the method further comprising:
determining the current location of the client computing device for each available service provider user from the list of service providers;
determining a second subset of the list of events that are to occur during a second future period of time;
determining the location associated with each event in the second subset of the list of events;
selecting a second particular available service provider from the list of service providers for a particular event in the second subset of the list of events based on a ranking of the second particular available service provider and a current location of the second particular available service provider and the location associated with the particular event in the second subset of the list of events; and
transmitting the notification to the client computing device associated with the second particular available service provider and receiving the confirmation from the client computing device that indicates whether the second available service provider accepts or declines the particular event in the second subset of the list of events.

18. The method of claim 12, further comprising displaying on a user interface the current location of each available service provider and the location associated with each event in the list of events.

19. The method of claim 12, wherein the rental request is a vehicle rental request.

20. The method of claim 12, wherein the rental request is one of a vehicle delivery request and a vehicle retrieval request.

21. The method of claim 12, further comprising selecting a particular available service provider from the list of service providers for a particular event in the subset of the list of events, the particular available service provider having a lowest time to travel between the current location of the particular available service provider and the location associated with the particular event in the subset of the list of events.

22. The method of claim 12, further comprising selecting an optimal assignment of the list of service providers to the subset of the list of events, the optimal assignment having a minimum total distance traveled by the list of service providers.

23. A non-transitory computer-readable storage medium, having instructions stored thereon that, when executed by a computing device cause the computing device to perform operations, the operations comprising:
receiving at least one rental request and storing the rental request as an event in a list of events in a database;
determining a current location of a client computing device for each available service provider user from a list of service providers;
determining a subset of the list of events that are to occur during a future period of time;
determining a location associated with each event in the subset of the list of events;
selecting a particular available service provider from the list of service providers for a particular event in the subset of the list of events, the particular available service provider selected based on a ranking of the particular available service provider and the particular available service provider having a lowest distance between the current location of the particular available service provider and the location associated with the particular event in the subset of the list of events; and
transmitting a notification to the client computing device associated with the particular available service provider and receiving a confirmation from the client computing device that indicates whether the particular available service provider accepts or declines the particular event in the subset of the list of events.

24. The non-transitory computer-readable storage medium of claim 23, the operations further comprising adding the particular event to the list of events when the available service provider declines the particular event.

25. The non-transitory computer-readable storage medium of claim 23, the operations further comprising removing the particular event from the list of events when the available service provider accepts the particular event.

26. The non-transitory computer-readable storage medium of claim 23, the operations further comprising selecting the particular available service provider from the list of service providers based on vehicle availability associated with a rental request and traffic information.

27. The non-transitory computer-readable storage medium of claim 23, the operations further comprising transmitting a deep link to turn-by-turn navigation information to the client computing device from the current location of the particular available service provider to the location associated with the particular event.

28. The non-transitory computer-readable storage medium of claim 23, wherein the subset of the list of events is a first subset of the list of events, the future period of time is a first future period of time, and the particular available service provider is a first particular available service provider, the operations further comprising:
determining the current location of the client computing device for each available service provider user from the list of service providers;
determining a second subset of the list of events that are to occur during a second future period of time;
determining the location associated with each event in the second subset of the list of events;
selecting a second particular available service provider from the list of service providers for a particular event in the second subset of the list of events based on a ranking of the second particular available service provider and a current location of the second particular available service provider and the location associated with the particular event in the second subset of the list of events; and
transmitting the notification to the client computing device associated with the second particular available service provider and receiving the confirmation from the client computing device that indicates whether the second available service provider accepts or declines the particular event in the second subset of the list of events.

29. The non-transitory computer-readable storage medium of claim 23, the operations further comprising displaying on a user interface the current location of each available service provider and the location associated with each event in the list of events.

30. The non-transitory computer-readable storage medium of claim 23, wherein the rental request is a vehicle rental request.

31. The non-transitory computer-readable storage medium of claim 23, wherein the rental request is one of a vehicle delivery request and a vehicle retrieval request.

32. The non-transitory computer-readable storage medium of claim 23, the operations further comprising selecting a particular available service provider from the list of service providers for a particular event in the subset of the list of events, the particular available service provider having a lowest time to travel between the current location of the particular available service provider and the location associated with the particular event in the subset of the list of events.

33. The non-transitory computer-readable storage medium of claim 23, the operations further comprising selecting an optimal assignment of the list of service providers to the subset of the list of events, the optimal assignment having a minimum total distance traveled by the list of service providers.
